(19) United States
(12) Patent Application Publication
(10) Pub. No.: US 2026/0311059 A1
(43) Pub. Date: Oct. 8, 2026

(54) SYSTEMS AND METHODS FOR LIST-BASED DATASET OPTIMIZATION FOR TRAINING OF MACHINE LEARNING ALGORITHMS

(71) Applicant: SAVVI AI INC., Kentfield, CA (US)

(72) Inventors: Kimberly Dorn, Kentfield, CA (US); Alex Muller, Kentfield, CA (US)

(73) Assignee: SAVVI AI INC., Kentfield, CA (US)

(21) Appl. No.: 19/636,759

(22) Filed: Apr. 1, 2026

Related U.S. Application Data
(60) Provisional application No. 63/782,512, filed on Apr. 2, 2025.

(51) Int. Cl. G06N 20/00

(52) U.S. Cl. CPC G06N 20/00

(57) ABSTRACT

The present disclosure relates generally to systems and methods for generating and encoding columns corresponding to element sets that include elements that do not co-occur within the original list columns in the original dataset. This updated dataset may be used to dynamically train machine learning algorithms that support text input while minimizing the amount of data that needs to be included in the dataset.

### CROSS-REFERENCE TO RELATED APPLICATIONS

The present patent application claims the priority benefit of U.S. Provisional Patent Application Number 63/782,512 filed Apr. 2, 2025, the disclosures of which are incorporated by reference herein.

### FIELD

The present disclosure relates generally to systems and methods for optimizing datasets including list columns and used for training of machine learning algorithms. More specifically, the present disclosure related to systems and methods for transforming list columns into columns through group encoding of individual list elements.

### SUMMARY

Disclosed embodiments provides a framework for optimizing datasets including list columns and used for training of machine learning algorithms. According to some embodiments, a computer-implemented method is provided. The computer-implemented method comprises receiving an initial dataset for training of a machine learning algorithm. The initial dataset includes a set of list columns. Further, the set of list columns includes corresponding sets of string values. The computer-implemented method further comprises extracting individual string values from the sets of string values. The computer-implemented method further comprises generating an adjacency graph over the individual string values. Adjacencies in the adjacency graph are defined according to co-occurrence of the individual string values within the initial dataset. The computer-implemented method further comprises constructing a set of encoding groups. The set of encoding groups is generated according to different string values not mutually adjacent according to the adjacency graph. The computer-implemented method further comprises generating an optimized dataset. The optimized dataset is generated by encoding the initial dataset as a set of columns according to the set of encoding groups. The computer-implemented method further comprises providing the optimized dataset. When the optimized dataset is provided, the optimized dataset is used to train the machine learning algorithm.

In some embodiments, the adjacency graph includes nodes corresponding to the individual string values and a set of edges corresponding to the adjacencies.

In some embodiments, the computer-implemented method further comprises determining that a frequency of occurrence associated with a string value within the initial dataset fails to satisfy a threshold frequency value. The computer-implemented method further comprises omitting the string value from the adjacency graph.

In some embodiments, an encoding group from the set of encoding groups is generated by selecting mutually non-adjacent elements according to the adjacency graph.

In some embodiments, the computer-implemented method further comprises receiving an update to the initial dataset. The update includes a new set of list columns and a corresponding new set of string values. The computer-implemented method further comprises modifying the adjacency graph and the set of encoding groups according to the new set of string values. The computer-implemented method further comprises generating a new optimized dataset according to the modified set of encoding groups.

In some embodiments, the set of columns is defined such that an individual column from the set of columns corresponds to an individual encoding group from the set of encoding groups.

In some embodiments, the adjacency graph is generated using a greedy set creation algorithm.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 shows an illustrative example of an environment in which a dataset optimization system converts an initial dataset into an optimized dataset that includes a set of columns according to a set of encoding groups generated from the initial dataset in accordance with at least one embodiment;

FIG. 2 shows an illustrative example of an environment in which a dataset optimization system processes an initial dataset to identify encoding groups for generation of an optimized dataset in accordance with at least one embodiment;

FIG. 3 shows an illustrative example of an environment in which an adjacency graph generator of a dataset optimization system processes a set of list columns and corresponding elements from an initial dataset to generate an adjacency graph in accordance with at least one embodiment;

FIG. 4 shows an illustrative example of an environment in which an encoding group identification module evaluates an adjacency graph to identify and generate distinct encoding groups for an optimized dataset in accordance with at least one embodiment;

FIG. 5 shows an illustrative example of an environment in which a dataset generator of the dataset optimization system processes the elements from the initial dataset and newly identified encoding groups to generate an optimized dataset in accordance with at least one embodiment;

FIG. 6 shows an illustrative example of a process for generating an optimized dataset including columns according to a set of encoding groups constructed according to elements not co-occurring within an initial dataset in accordance with at least one embodiment;

FIG. 7 shows an illustrative example of a process for updating an optimized dataset in response to receiving an updated initial dataset in accordance with at least one embodiment; and

FIG. 8 shows an illustrative example of an environment in which various embodiments can be implemented.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

There is a need in the art for methods of converting datasets constructed using list columns into optimized datasets that can be used for training of machine learning algorithms. Datasets constructed using list columns typically are not natively supported by machine learning algorithm. Traditionally, the transformation of list columns within a dataset into text-based columns that can be processed by machine learning algorithms would involve an identification of the different individual elements included in the list columns and generating individual columns for each of these different individual elements. For each data point within the dataset, a binary indicator (e.g., 1 or 0) would be used to denote the presence of an element through each of the individual columns. However, for datasets including a vast number of possible list elements, the text-based dataset created for training machine learning algorithms may include a column for each of these possible list elements, resulting in a dataset that consumes a large amount of storage capacity. Further, a machine learning algorithm that is to be trained using this dataset may be required to process each datapoint according to each column, which can be resource intensive (e.g., use significant processing power and memory, etc.). Thus, there is a need to optimize these text-based datasets in order to reduce the resources required for training of machine learning algorithms.

The systems and methods described herein address this need and others by providing a computer system that generates and encodes columns corresponding to element sets that include elements that do not co-occur within the original list columns in the original dataset. This updated dataset may be used to dynamically train machine learning algorithms that support text input while minimizing the amount of data that needs to be included in the dataset.

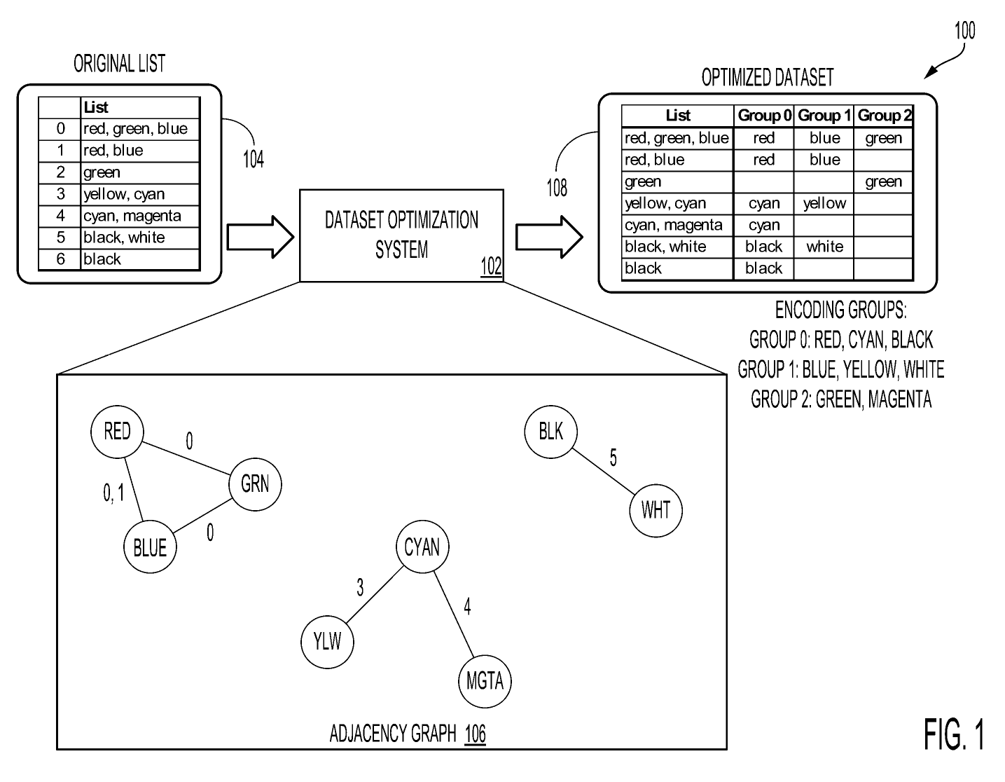

FIG. 1 shows an illustrative example of an environment 100 in which a dataset optimization system 102 converts an initial dataset 104 into an optimized dataset 108 that includes a set of columns according to a set of encoding groups generated from the initial dataset 104 in accordance with at least one embodiment. In the environment 100, the dataset optimization system 102 may receive an initial dataset 104 that includes a set of list columns. A list column within the initial dataset 104 may include a set of string values in each row. For example, the initial dataset 104 may include a single list column corresponding to different colors that are included in each distinct data point within the initial dataset 104. The first row, or data point, within the initial dataset 104 may include a list of three colors: red, green, and blue; the second row, or data point, within the initial dataset 104 may include a list of two colors: red and blue; and so on. Accordingly, the initial dataset 104 may provide, for each datapoint, a distinct list of elements.

In some instances, machine learning algorithms may not natively support datasets comprising list columns, such as the initial dataset 104. Accordingly, these datasets may need to be transformed into new datasets that may be processed by these machine learning algorithms and, thus, facilitate training of these machine learning algorithms. Traditionally, this transformation process is performed by evaluating the original or initial dataset to identify the different elements that are included in each of the lists or data points in the dataset. Returning to the illustrative example provided in FIG. 1, through this traditional transformation process, a system may identify eight distinct elements: red, green, blue, yellow, cyan, magenta, black, and white. For each of these distinct elements, the system may generate a distinct column, resulting in a new dataset comprising eight columns corresponding to the eight distinct elements identified from the initial dataset. The system may further indicate, in each row of the new dataset, a binary indicator (e.g., “0” or “1”) that may serve to indicate whether the particular element is present within the data point (i.e., a list provided in the initial dataset). As an illustrative example, for the first row of the initial dataset 104 (e.g., a list including the elements red, green, and blue), the system may populate the first row of the new dataset with “1” under the columns corresponding to the red, green, and blue elements and with “0” under the other columns, resulting in eight values for the datapoint. As the initial dataset 104 includes seven distinct lists or rows, the resulting new dataset may include a matrix of 56 total binary values (e.g., seven lists * eight possible elements).

For larger datasets (e.g., datasets including thousands of possible elements and a significant number of lists or data points, etc.), the traditional transformation process may produce a dataset including a distinct row for each possible element from the thousands of possible elements. As a result, each data point is represented by an array of thousands of values corresponding to these possible elements. For an initial dataset including thousands of data points and thousands of possible elements, the resulting transformed dataset may include millions of values. This transformed dataset may consume significant storage capacity within systems configured to store datasets for training of machine learning algorithms. Further, a machine learning algorithm being trained using such datasets may need to process each value associated with each data point, resulting in significant resource (e.g., memory, processing, etc.) utilization. As the training of machine learning algorithms may require multiple iterations depending on the accuracy of outputs generated by these machine learning algorithms, these datasets may need to be processed multiple times, further compounding any resource utilization issues. Thus, there is a need to improve the performance of the systems used to train machine learning algorithms by optimizing the aforementioned transformation process.

In an embodiment, a dataset optimization system 102 is implemented to transform an initial dataset 104 into an optimized dataset 108 that encodes columns corresponding to element sets that include elements that do not co-occur within the original list columns in the initial dataset 104. As illustrated in FIG. 1, the dataset optimization system 102 may receive, as input, an initial dataset 104 comprising a set of list columns and corresponding rows including distinct lists that may serve as data points for training of machine learning algorithms. As noted above, a list within the initial dataset 104 may include a set of distinct elements that may comprise the list. Returning to an earlier example, the first row, or data point, within the initial dataset 104 may include a list including three colors: red, green, and blue; the second row, or data point, within the initial dataset 104 may include a list including two colors: red and blue; and so on.

In an embodiment, the dataset optimization system 102 processes the initial dataset 104 to create an adjacency graph 106 for elements in the initial dataset 104. The adjacency graph 106 may include elements that are co-occurring within the initial dataset 104 such that there are defined relationships amongst these elements. For example, from the initial dataset 104, the dataset optimization system 102 may identify an initial adjacency graph including the elements red, green, and blue as a result of these elements being adjacent to each other. This initial adjacency graph may be identified based on the first data point within the initial dataset 104, which includes the elements red, green, and blue. When the dataset optimization system 102 processes the fourth data point of the initial dataset 104 (e.g., the list comprising the elements yellow and cyan), the dataset optimization system 102 may add new nodes to the adjacency graph for the elements yellow and cyan. However, upon processing the fifth data point (e.g., the list comprising the elements cyan and magenta), the dataset optimization system 102 may determine that the element cyan, which co-occurs with the element yellow, also co-occurs with the element magenta. Accordingly, the dataset optimization system 102 may add an edge to the adjacency graph and joining the elements cyan and magenta. This process of populating the adjacency graph may continue until the dataset optimization system 102 has evaluated all lists of the initial dataset 104 and has identified and grouped all co-occurring elements within the initial dataset 104. In an embodiment, the dataset optimization system 102 implements a greedy set creation algorithm to generate the initial adjacency graph from the myriad lists included in the initial dataset 104.

In an embodiment, the dataset optimization system 102 further evaluates the initial dataset 104 to determine the frequency of each list element appearing within the initial dataset 104. Based on the frequency of each list element appearing within the initial dataset 104, the dataset optimization system 102 may determine whether a list element may be used in the generation of the adjacency graph. For instance, the dataset optimization system 102 may implement a threshold frequency value that denotes a minimum frequency (i.e., number of times) that an element represented in the initial dataset 104 is required to maintain in order to be incorporated into an adjacency graph of co-occurring elements. If the dataset optimization system 102 identifies a list element within the initial dataset 104 that does not satisfy this threshold frequency value, the dataset optimization system 102 may omit this list element when generating the adjacency graph.

In an embodiment, the dataset optimization system 102 provides the adjacency graph 106 through an interface (such as a graphical user interface (GUI)) to users of the dataset optimization system 102. For instance, when a user of the dataset optimization system 102 submits a request to optimize an initial dataset 104 for use in training of one or more machine learning algorithms, the dataset optimization system 102 may update a GUI provided by the dataset optimization system 102 (such as through an application provided by the dataset optimization system 102 or through a web portal provided by the dataset optimization system 102 and accessed through a browser application implemented on the user’s computing device) to display the adjacency graph 106. This may allow the user to evaluate the adjacency graph 106 generated by the dataset optimization system 102.

In an embodiment, the dataset optimization system 102 processes the adjacency graph 106 to generate a set of encoding groups that include elements that do not co-occur within the adjacency graph 106. To generate a new encoding group, the dataset optimization system 102 may select one element at a time such that each successive element does not co-occur with any prior element and create a new list that includes these selected elements. For example, from the adjacency graph 106, the dataset optimization system 102 may select the element “red”, the element “cyan”, and the element “black” from the adjacency graph 106 resulting in the encoding group [red, cyan, black]. Subsequently, the dataset optimization system 102 may select the element “blue”, the element “yellow”, and the element "white” from the adjacency graph 106 resulting in the encoding group [blue, yellow, white]. The final encoding group, [green, magenta], is generated from the adjacency graph 106 from the remaining elements not previously selected by the dataset optimization system 102.

The set of encoding groups are generated by the dataset optimization system 102 such that, for each list provided in the initial dataset 104, only one list element from the list can be represented within an encoding group. For example, the first data point from the initial dataset 104 (i.e., the list comprising the elements red, green, and blue) may be represented as including the element “red” within the encoding group [red, cyan, black]; the element “blue” within the encoding group [blue, yellow, white], and the element “green” within the encoding group [green, magenta]. The configuration of these encoding groups by the dataset optimization system 102 ensures that for each list provided in an initial dataset 104, the entry corresponding to a particular encoding group may include, at most, one element from the list.

In an embodiment, once the dataset optimization system 102 has generated a set of encoding groups from the adjacency graph 106, the dataset optimization system 102 dynamically generates an optimized dataset 108 that can be used for training of machine learning algorithms. The dataset optimization system 102 may configure the optimized dataset 108 to include a set of columns, where a column may correspond to a particular encoding group generated from the adjacency graph 106. For instance, as illustrated in FIG. 1, the dataset optimization system 102 has generated an optimized dataset 108 containing three distinct columns corresponding to the encoding groups generated from adjacency graph 106. Further, each row within the optimized dataset 108 may correspond to the original lists or data points included within the initial dataset 104.

A data point within the optimized dataset 108 (i.e., row) may be represented or encoded using the actual and distinct elements included in the data point and corresponding to each of the encoding groups. Returning to an earlier illustrative example, where the first data point from the initial dataset 104 includes the elements red, green, and blue and the dataset optimization system 102 has generated three distinct encoding groups (i.e., encoding group [red, cyan, black], encoding group [blue, yellow, white], and encoding group [green, magenta], the dataset optimization system 102 may define this first data point within the optimized dataset 108 by including the text “red” under the column corresponding to the first encoding group (i.e., [red, cyan, black]), the text “blue” under the column corresponding to the second encoding group (i.e., [blue, yellow, white]), and the text “green” under the column corresponding to the third encoding group (i.e., [green, magenta]).

The optimized dataset 108 may provide a more concise definition of the different data points included in the original dataset 104 as opposed to a dataset generated using traditional transformation processes. As noted above, through a traditional transformation process, a system may identify from the initial dataset 104 eight distinct elements: red, green, blue, yellow, cyan, magenta, black, and white. For each of these distinct elements, the system may generate a distinct column, resulting in a new dataset comprising eight columns corresponding to the eight distinct elements identified from the initial dataset. For each data point in the initial dataset 104, the resulting row within the new dataset may include eight binary values that may be used to denote the presence or absence of an element within the data point. However, through the process executed by the dataset optimization system 102, the resulting optimized dataset 108 may include three columns corresponding to the three encoding groups generated by the dataset optimization system 102, thereby reducing the amount of data required to represent the various data points from the initial dataset 104. This may have several benefits. For instance, the reduction in data required to represent the various data points from the initial dataset 104 may lead to a reduction in storage required to maintain the optimized dataset 108. Further, the training of a machine learning algorithm using an optimized dataset 108 may require fewer resources, as the machine learning algorithm may be required to process less data in the optimized dataset 108 to produce the same output. As the training of machine learning algorithms may require multiple iterations depending on the accuracy of outputs generated by these machine learning algorithms, these datasets may need to be processed multiple times, further reducing resource utilization compared to traditional training processes using sub-optimal training datasets.

In an embodiment, the dataset optimization system 102 can further refine an optimized dataset 108 according to new data points that may be used to further train machine learning algorithms. For instance, if a user of the dataset optimization system 102 provides an update to the initial dataset 104, whereby the update includes a new set of data points (i.e., lists) containing one or more new elements not previously processed by the dataset optimization system 102, the dataset optimization system 102 may process the updated initial dataset to determine whether an update to the distinct element clusters is required. For example, if the updated initial dataset includes one or more new elements not previously processed by the dataset optimization system 102 when generating the adjacency graph 106, the dataset optimization system 102 may dynamically process the updated initial dataset to generate a new adjacency graph that incorporates the relationships among the one or more new elements and the elements previously processed by the dataset optimization system 102. For instance, using the greedy set creation algorithm, the dataset optimization system 102 may process the different lists within the updated initial dataset to generate a new adjacency graph that covers the new universe of possible elements provided in the updated initial dataset. Accordingly, the dataset optimization system 102 may process the new adjacency graph to define new and/or modified encoding groups for the optimized dataset and populate each row with the corresponding elements defined in the updated initial dataset.

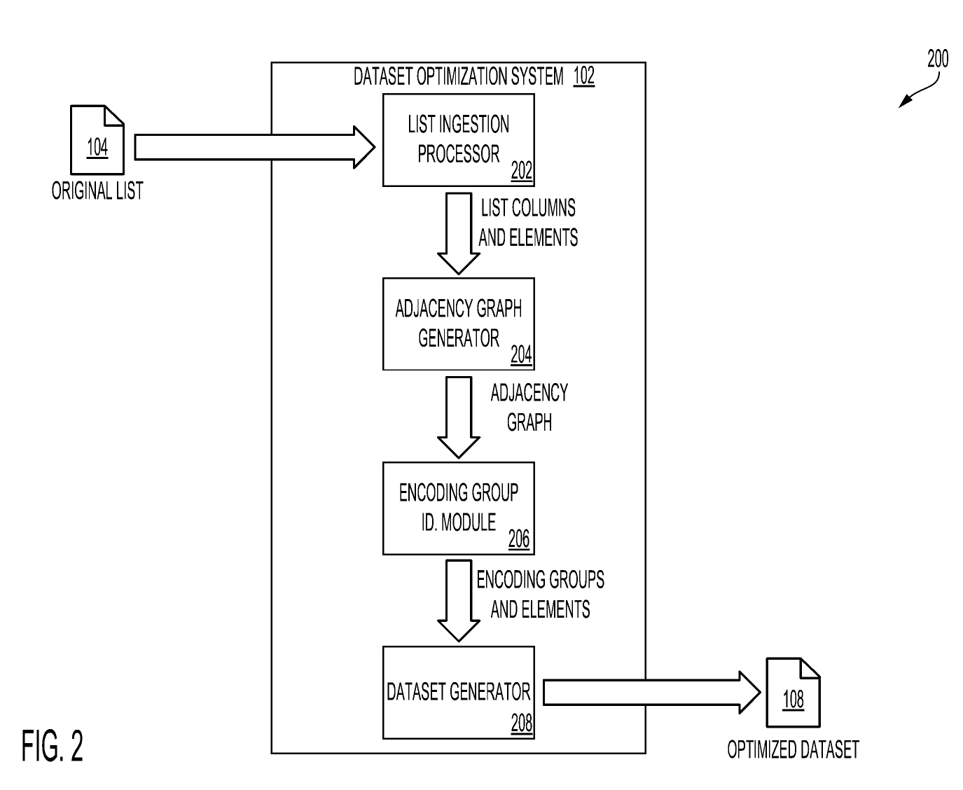

FIG. 2 shows an illustrative example of an environment 200 in which a dataset optimization system 102 processes an initial dataset 104 to identify encoding groups for generation of an optimized dataset 108 in accordance with at least one embodiment. In the environment 200, the dataset optimization system 102, through a list ingestion processor 202, may receive an initial dataset 104 comprising one or more list columns and corresponding data points (i.e., lists). These data points may include different elements or string values that may be used to dynamically train different machine learning algorithms. As an illustrative example of an initial dataset 104, and as illustrated in FIG. 1, the initial dataset 104 may include a single list column corresponding to different colors that are included in each distinct data point within the initial dataset 104. The first row, or data point, within the initial dataset 104 may include a list of three colors: red, green, and blue; the second row, or data point, within the initial dataset 104 may include a list of two colors: red and blue; and so on. Accordingly, the initial dataset 104 may provide, for each datapoint, a distinct list of elements. Further, in aggregate, the initial dataset 104 may define a universe of possible elements or string values that may be used to define each data point within the initial dataset 104.

The list ingestion processor 202 may be implemented on a computer system or other system (e.g., server, virtual machine instance, etc.) associated with the dataset optimization system 102. In an embodiment, in response to receiving an initial dataset 104 from a user or other entity, the list ingestion processor 202 evaluates the initial dataset 104 to identify the universe of possible elements or string values that make up the different data points within the initial dataset 104. For example, returning to the illustrative example provided in FIG. 1, the list ingestion processor 202 may evaluate each data point (i.e., row or individual list) within the initial dataset 104 to determine that the universe of possible elements includes eight distinct elements: red, green, blue, yellow, cyan, magenta, black, and white. In some instances, a user of the dataset optimization system 102, when providing the initial dataset 104, may define the universe of possible elements. In such instances, the list ingestion processor 202 may evaluate the initial dataset 104 to determine whether any elements defined by the user are absent from the initial dataset 104. For example, if the user has indicated that in addition to the colors listed above the universe of possible elements includes the color brown (which is not included in any of the data points in the initial dataset 104), the list ingestion processor 202 may indicate that the initial dataset 104 does not include this element within any of the data points of the initial dataset 104. This may cause the user to revise their definition of the universe of possible elements. In some instances, the list ingestion processor 202 may automatically remove any elements from the universe of possible elements that are not used within the initial dataset 104.

In an embodiment, the list ingestion processor 202 can refine the universe of possible list elements based on the frequency in which each element is present within the initial dataset 104. For instance, in an embodiment, the list ingestion processor 202 evaluates the initial dataset 104 to determine the frequency of each list element appearing within the initial dataset 104 in relation to the size of the initial dataset 104 (e.g., number of different data points) and appearance of other list elements within the initial dataset 104. The list ingestion processor 202 may process the initial dataset 104 and tabulate or record the number of times each element occurs within the initial dataset 104 in relation to the number of data points or lists included in the initial dataset 104. For example, returning to the illustrative example provided in FIG. 1, the element “red” appears twice within the initial dataset 104. As the initial dataset 104 includes seven data points, the list ingestion processor 202 may determine that the element “red” has a frequency of 2/7 or 0.286.

The list ingestion processor 202 may implement a threshold frequency value or other frequency threshold that may be used to determine whether to include an element within the universe of possible elements for processing of the initial dataset 104. The threshold frequency value or other frequency threshold may denote the minimum frequency (e.g., number of times, appearance ratio or percentage, etc.) that an element is required to appear in the initial dataset 104 in order to be included in the universe of possible elements for creation of an optimized dataset. In some instances, the threshold frequency value or other frequency threshold may be pre-defined, whereby the dataset optimization system 102 or other entity (e.g., an administrator of the dataset optimization system 102, etc.) may configure the list ingestion processor 202 with a default threshold frequency value or other frequency threshold for evaluating initial datasets. If the list ingestion processor 202 identifies, from the initial dataset 104, a list element that does not satisfy this threshold frequency value or other frequency threshold, the list ingestion processor 202 may omit this element from the universe of possible list elements that may be considered when generating the optimized dataset 108.

Once the list ingestion processor 202 has defined the universe of possible list elements from the initial dataset 104, the list ingestion processor 202 may transmit data corresponding to this universe of possible list elements and the data points from the initial dataset 104 to an adjacency graph generator 204. The adjacency graph generator 204 may be implemented on a computer system or other system (e.g., server, virtual machine instance, etc.) associated with the dataset optimization system 102. In an embodiment, the adjacency graph generator 204 processes the different data points from the initial dataset 104 in accordance with the provided data corresponding to the universe of possible list elements to generate an adjacency graph. For instance, the adjacency graph generator 204 may process the different data points from the initial dataset 104 to generate an adjacency graph that incorporates the data points included in the initial dataset 104. As noted above, the adjacency graph may include different list elements that are co-occurring within the initial dataset 104 and, thus, defines relationships amongst these different list elements. Returning to the illustrative example presented in FIG. 1, from the data points extracted from the initial dataset 104, the adjacency graph generator 204 may identify an initial adjacency graph that includes the elements red, green, and blue. This initial adjacency graph may be identified based on the first data point from the initial dataset 104, which includes the elements red, green, and blue. When the adjacency graph generator 204 processes the fourth data point of the initial dataset 104 (e.g., the list comprising the elements yellow and cyan), the adjacency graph generator 204 may add new nodes to the initial adjacency graph and corresponding to the elements yellow and cyan. However, upon processing the fifth data point (e.g., the list comprising the elements cyan and magenta), the adjacency graph generator 204 may determine that the element cyan, which co-occurs with the element yellow, also co-occurs with the element magenta. Accordingly, the adjacency graph generator 204 may add an edge to the adjacency graph and joining the elements cyan and magenta. This process of populating the adjacency graph may continue until the adjacency graph generator 204 has evaluated all of the lists from the initial dataset 104 and has identified and grouped all co-occurring elements within the initial dataset 104. In an embodiment, the adjacency graph generator 204 implements a greedy set creation algorithm to generate the adjacency graph from the lists included in the initial dataset 104.

In an embodiment, the adjacency graph generator 204 provides the adjacency graph through an interface (such as a GUI) to users of the dataset optimization system 102. For instance, when a user of the dataset optimization system 102 submits a request to optimize an initial dataset 104 for use in training of one or more machine learning algorithms, the adjacency graph generator 204 may update a GUI provided by the dataset optimization system 102 (such as through an application provided by the dataset optimization system 102 or through a web portal provided by the dataset optimization system 102 and accessed through a browser application implemented on the user’s computing device) to display the adjacency graph. This may allow the user to evaluate the adjacency graph generated by the adjacency graph generator 204.

Once the adjacency graph generator 204 has generated a new adjacency graph from the initial dataset 104, the adjacency graph generator 204 may transmit the adjacency graph to an encoding group identification module 206. The encoding group identification module 206 may be implemented on a computer system or other system (e.g., server, virtual machine instance, etc.) associated with the dataset optimization system 102. In an embodiment, the encoding group identification module 206 processes the adjacency graph to generate a set of encoding groups that include elements that do not co-occur within the adjacency graph. As noted above, to generate a new encoding group, the encoding group identification module 206 may select one element at a time such that each successive element does not co-occur with any prior element.

As noted above, the set of encoding groups may be generated by the encoding group identification module 206 such that, for each data point or list provided in the initial dataset 104, only one list element from the list can be represented within an encoding group. Returning to the illustrative example provided in FIG. 1, the first data point from the initial dataset 104 (i.e., the list comprising the elements red, green, and blue) may be represented as including the element “red” within the encoding group [red, cyan, black]; the element “blue” within the encoding group [blue, yellow, white], and the element “green” within the encoding group [green, magenta]. The configuration of these encoding groups by the encoding group identification module 206 ensures that for each data point or list provided in an initial dataset 104, an entry corresponding to a particular encoding group may include, at most, one element from the data point or list.

In an embodiment, the encoding group identification module 206 provides the newly generated encoding groups and the data points/lists from the initial dataset 104 to a dataset generator 208 for generation of the optimized dataset 108. The dataset generator 208 may be implemented on a computer system or other system (e.g., server, virtual machine instance, etc.) associated with the dataset optimization system 102. The dataset generator 208, in an embodiment, configures the optimized dataset 108 to include a set of text-based columns corresponding to the different encoding groups generated by the encoding group identification module 206. A text-based column within the optimized dataset 108 may correspond to a particular encoding group generated by the encoding group identification module 206 from the set of element clusters. Further, each row within the optimized dataset 108 may correspond to an original list or data point included within the initial dataset 104.

The dataset generator 208, in an embodiment, represents or otherwise encodes a data point or list within the optimized dataset 108 using the actual and distinct list elements included in the data point and according to the encoding groups (i.e., columns) represented in the optimized dataset 108. Returning to the earlier illustrative example provided in FIG. 1, where the first data point from the initial dataset 104 includes the elements red, green, and blue and the encoding group identification module 206 has generated three distinct encoding groups (i.e., encoding group [red, cyan, black], encoding group [blue, yellow, white], and encoding group [green, magenta]), the dataset generator 208 may define this first data point within the optimized dataset 108 by including the text “red” under the column corresponding to the first encoding group (i.e., [red, cyan, black]), the text “blue” under the column corresponding to the second encoding group (i.e., [blue, yellow, white]), and the text “green” under the column corresponding to the third encoding group (i.e., [green, magenta]). The dataset generator 208 may provide this newly generated optimized dataset 108 to a requesting user for use in training machine learning algorithms. Alternatively, the dataset generator 208 may automatically use the newly generated optimized dataset 108 to train one or more machine learning algorithms implemented by a system or service that provides the dataset optimization system 102.

In an embodiment, the list ingestion processor 202 can dynamically modify the universe of possible list elements in response to receiving an updated dataset comprising new data points and/or new list elements. For instance, if a user of the dataset optimization system 102 provides an update to the initial dataset 104, whereby the update includes a new set of data points (i.e., lists) containing one or more new list elements not previously processed by the dataset optimization system 102, the list ingestion processor 202 may process the updated initial dataset to determine whether an update to the adjacency graph is required. For instance, the list ingestion processor 202 may evaluate each data point (i.e., row or individual list) within the updated initial dataset to determine the new universe of possible list elements. Further, the list ingestion processor 202, subject to the aforementioned threshold frequency value or other frequency threshold, may refine the new universe of possible list elements to include list elements that are represented within the updated initial dataset and that satisfy this threshold frequency value or other frequency threshold.

The list ingestion processor 202 may transmit this new universe of possible list elements and the data points from the updated initial dataset to the adjacency graph generator 204 for generation of an updated adjacency graph. For instance, using the aforementioned greedy set creation algorithm, the adjacency graph generator 204 may generate a new adjacency graph from the new pool of data points provided by the list ingestion processor 202 and according to the updated universe of possible list elements. As the new pool of data points may include additional co-occurring list elements, the adjacency graph generator 204, through the greedy set creation algorithm, may identify new and/or alternative relationships among different list elements according to the new universe of possible list elements. The adjacency graph generator 204 may use these new and/or alternative relationships (as well as the previously identified relationships among previously reviewed list elements) to dynamically construct a new adjacency graph that illustrates these different relationships among the list elements included within the updated initial dataset and belonging to the new universe of possible list elements.

As the new adjacency graph generated from the updated initial dataset may differ from the previously generated adjacency graph, the adjacency graph generator 204 may provide the newly generated adjacency graph and the new pool of data points from the updated initial dataset to the encoding group identification module 206 for generation of a new set of encoding groups. As noted above, the set of encoding groups may be generated by the encoding group identification module 206 such that, for each data point or list provided in an initial dataset, only one list element from the list can be represented within an encoding group. Thus, for a new adjacency graph that includes additional and/or alternative list elements from an updated initial dataset, the encoding group identification module 206 may generate new encoding groups that include additional and/or alternative list elements that do not co-occur within the updated initial dataset.

The encoding group identification module 206 may provide the newly generated encoding groups and the data points/lists from the updated initial dataset to the dataset generator 208 for generation of a new optimized dataset. The dataset generator 208 may configure the new optimized dataset to include a new or modified set of text-based columns corresponding to the new encoding groups generated by the encoding group identification module 206 from the updated initial dataset. The dataset generator 208 may encode the new data points or lists within the new optimized dataset using the actual and distinct list elements included in the new data points and according to the new encoding groups (i.e., columns) represented in the new optimized dataset. The dataset generator 208 may provide this updated optimized dataset to a requesting user for use in training machine learning algorithms. Alternatively, the dataset generator 208 may automatically use the updated optimized dataset to train one or more machine learning algorithms implemented by a system or service that provides the dataset optimization system 102. Thus, as new data points are obtained, the dataset optimization system 102, through the aforementioned components, may dynamically update and optimize datasets that may be used to train or modify implemented machine learning algorithms.

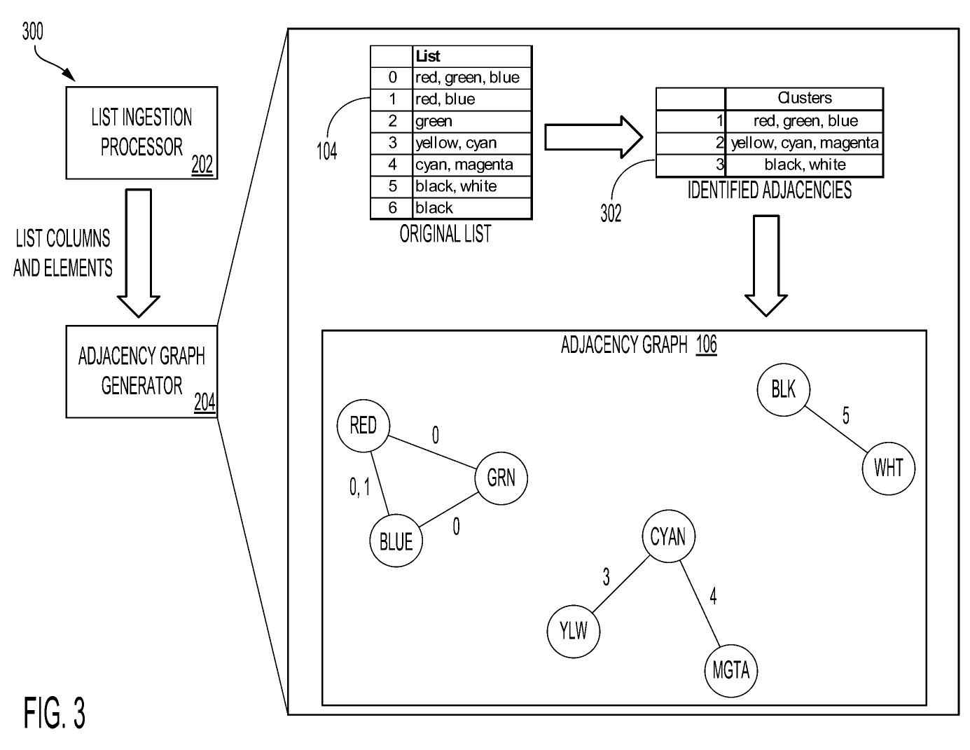

FIG. 3 shows an illustrative example of an environment 300 in which an adjacency graph generator 204 of a dataset optimization system processes a set of list columns and corresponding elements from an initial dataset 104 to generate an adjacency graph 106 in accordance with at least one embodiment. In the environment 300, the adjacency graph generator 204 may receive, from the list ingestion processor 202, data corresponding to a universe of possible list elements that may be presented within an initial dataset 104 provided to the dataset optimization system for creation of an optimized dataset. Additionally, the adjacency graph generator 204 may receive, from the list ingestion processor 202, the various data points or lists included in the provided initial dataset. As noted above, the list ingestion processor 202, in response to receiving an initial dataset 104 from a user or other entity, may evaluate the initial dataset 104 to identify the universe of possible list elements or string values that make up the different data points within the initial dataset 104. In some instances, a user of the dataset optimization system, when providing the initial dataset 104, may define the universe of possible elements. In such instances, the list ingestion processor 202 may evaluate the initial dataset 104 to determine whether any elements defined by the user are absent from the initial dataset 104. If the list ingestion processor 202 identifies any absent elements, the list ingestion processor 202 may indicate that the initial dataset 104 does not include these elements within any of the data points of the initial dataset 104. This may cause the user to revise their definition of the universe of possible elements. In some instances, the list ingestion processor 202 may automatically remove any elements from the universe of possible elements that are not used within the initial dataset 104. In an embodiment, the list ingestion processor 202 further evaluates the initial universe of possible list elements according to a threshold frequency value or other frequency threshold. Based on this threshold, the list ingestion processor 202 may refine the universe of possible list elements to include only the list elements that are represented within the initial dataset and that satisfy this threshold frequency value or other frequency threshold.

In response to obtaining the data points/lists corresponding to the initial dataset 104 and data corresponding to the universe of possible list elements from the list ingestion processor 202, the adjacency graph generator 204 may process the different data points from the initial dataset 104 to identify sets of element adjacencies 302 within the initial dataset 104. A set of element adjacencies may include different list elements that are co-occurring within the initial dataset 104 and, thus, defines a relationship amongst these different list elements. As illustrated in FIG. 3, from the data points extracted from the initial dataset 104, the adjacency graph generator 204 may identify a first set of element adjacencies including the elements red, green, and blue (as defined in the first data point of the initial dataset 104). As no other data point within the initial dataset 104 includes a larger list of elements that include red, green, or blue (i.e., the second data point includes only red and blue and the third data point only includes green), the adjacency graph generator 204 may define a first set of adjacencies that includes the co-occurring elements red, green, and blue. When the adjacency graph generator 204 processes the fourth data point of the initial dataset 104 (e.g., the list comprising the elements yellow and cyan), the adjacency graph generator 204 may initially identify a new set of adjacencies including the elements yellow and cyan. However, upon processing the fifth data point (e.g., the list comprising the elements cyan and magenta), the adjacency graph generator 204 may determine that the element cyan, which co-occurs with the element yellow, also co-occurs with the element magenta. Accordingly, the adjacency graph generator 204 may expand this new set of adjencies to include the element magenta, resulting in the new set of adjacencies including the list elements yellow, cyan, and magenta. This process of generating sets of adjacencies 302 may continue until the adjacency graph generator 204 has evaluated all data points or lists from the initial dataset 104 and has identified and grouped all co-occurring elements within the initial dataset 104 according to the universe of possible list elements into the largest possible sets of adjacencies.

As noted above, to identify the sets of adjacencies and relationships among the data points obtained from the initial dataset 104, the adjacency graph generator 204 may process these data points through a greedy set creation algorithm to identify these sets of adjacencies and relationships among these data points. For instance, the greedy set creation algorithm may process the different data points from the initial dataset 104 to identify the myriad adjacencies and other relationships among the elements from the universe of possible list elements that co-occur within the initial dataset 104.

The adjacency graph generator 204 may use the newly identified sets of adjacencies 302 to dynamically construct an adjacency graph 106 that illustrates these different sets of adjacencies and relationships among the list elements included within the initial dataset 104 and belonging to the universe of possible list elements. Each set of adjacencies represented in the adjacency graph 106 may be represented by a set of nodes corresponding to the list elements included in the set of adjacencies and a set of edges connecting these different nodes within the element cluster according to their co-occurrence within one or more data points or lists in the initial dataset 104. Each edge connecting a pair of nodes may be labeled to include identifiers corresponding to the data points (e.g., lists) that include the list elements corresponding to these nodes, thereby highlighting the co-occurrence of these elements within the indicated data points. For instance, as illustrated in FIG. 3, the adjacency graph generator 204 has identified three distinct sets of adjacencies. The edges of a set of adjacencies including the elements [red, green, blue] may denote that these list elements co-occur within the data point 0 of the initial dataset 104 and that the list elements red and blue further co-occur within data point 1 of the initial dataset 104. For the second set of adjacencies corresponding to the list elements [yellow, cyan, magenta], the edges may denote that the list elements yellow and cyan co-occur within data point 3 of the initial dataset 104 and that list elements yellow and magenta co-occur within data point 4 of the initial dataset 104. Further, for the third set of adjacencies represented through the adjacency graph 106 and including the list elements [black, white], the edges may denote that the list elements black and white co-occur within data point 5 of the initial dataset 104. Thus, a user of the dataset optimization system, through the provided adjacency graph 106, may readily identify the different sets of adjacencies and relationships among the elements within the provided initial dataset 104.

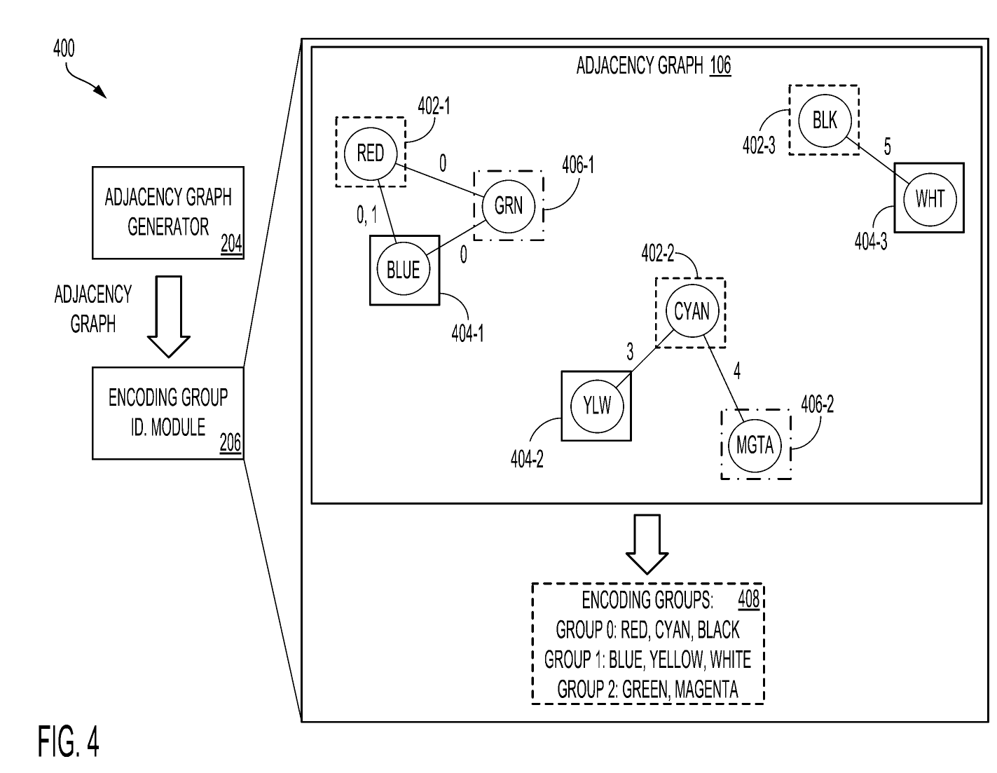

FIG. 4 shows an illustrative example of an environment 400 in which an encoding group identification module 206 evaluates an adjacency graph 106 to identify and generate distinct encoding groups 408 for an optimized dataset in accordance with at least one embodiment. In the environment 400, the encoding group identification module 206 receives, from the adjacency graph generator 204, the adjacency graph 106 generated by the adjacency graph generator 204 from the initial dataset. In an embodiment, the encoding group identification module 206 processes the adjacency graph 106 to generate a set of encoding groups 408 that include elements that do not co-occur within the adjacency graph 106.

To generate the set of encoding groups 408 from the adjacency graph 106, the encoding group identification module 206 may select an element from each set of adjacencies represented in the adjacency graph 106 and create a new list that includes these selected and non-co-occurring elements. For example, as illustrated in FIG. 4, the encoding group identification module 206 may select element 402-1 from a first set of adjacencies, element 402-2 from a second set of adjacencies, and element 402-3 from a third set of adjacencies to generate the first encoding group [red, cyan, black]. Once the encoding group identification module 206 has generated this first encoding group, the encoding group identification module 206 may remove these elements 402-1 – 402-3 from the pool of elements that may be used to generate the next element cluster. Accordingly, as illustrated in FIG. 4, the encoding group identification module 206 may select element 404-1 from the first set of adjacencies, element 404-2 from the second set of adjacencies, and element 404-3 from the third set of adjacencies to generate the second encoding group [blue, yellow, white]. The encoding group identification module 206 may subsequently remove the elements 404-1 – 404-3 from the pool of elements that may be used to generate the last element cluster comprising element 406-1 from the first set of adjacencies and element 406-2 from the second set of adjacencies (i.e., the third encoding group [green, magenta]).

The method for generating the encoding groups 408 ensures that, for each data point or list provided in the initial dataset, only one list element from the list can be represented within an encoding group. Returning to the illustrative example provided in FIG. 1, the first data point from the initial dataset (i.e., the list comprising the elements red, green, and blue) may be represented as including the element “red” within the first encoding group [red, cyan, black]; the element “blue” within the second encoding group [blue, yellow, white], and the element “green” within the third encoding group [green, magenta]. The configuration of the encoding groups 408 by the encoding group identification module 206 ensures that for each data point or list provided in an initial dataset, an entry corresponding to a particular encoding group may include, at most, one element from the data point or list.

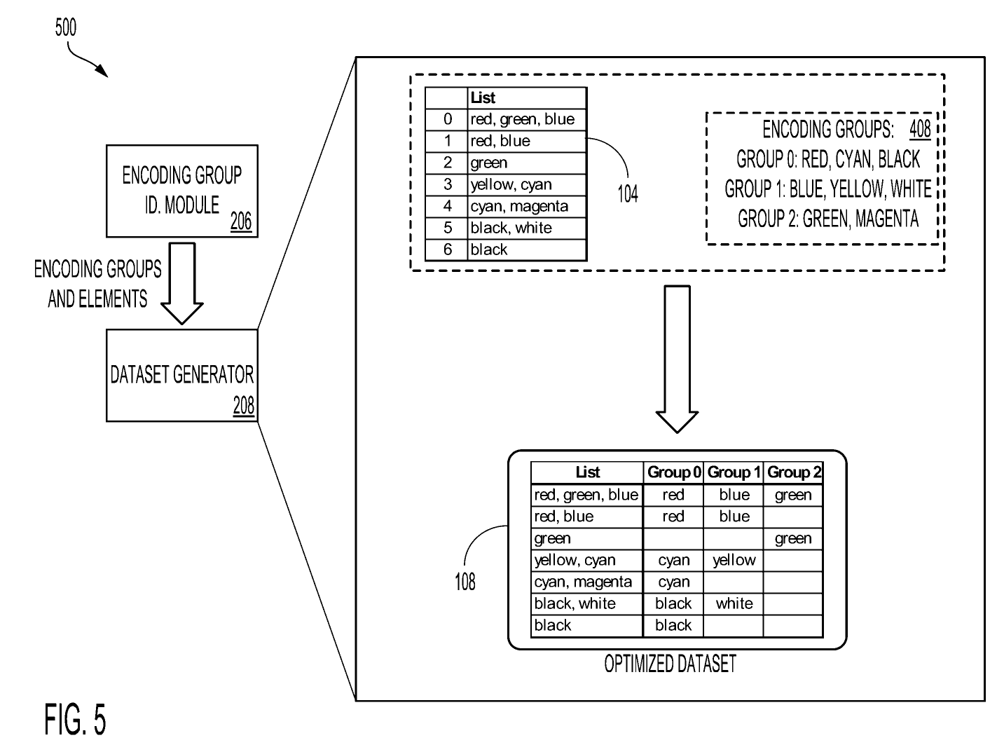

FIG. 5 shows an illustrative example of an environment 500 in which a dataset generator 208 of the dataset optimization system processes the elements from the initial dataset 104 and newly identified encoding groups 408 to generate an optimized dataset 108 in accordance with at least one embodiment. In the environment 500, the encoding group identification module 206 transmits the encoding groups 408 generated from the adjacency graph (as illustrated and described above in connection with FIG. 4), and the data points/lists from the initial dataset 104 to the dataset generator 208 for generation of an optimized dataset 108 that may be used to dynamically train one or more machine learning models. The dataset generator 208, in an embodiment, configures the optimized dataset 108 to include a set of text-based columns corresponding to the different encoding groups 408 generated by the encoding group identification module 206. As noted above, a text-based column within the optimized dataset 108 may correspond to a particular encoding group generated by the encoding group identification module 206 from the adjacency graph. Further, each row within the optimized dataset 108 may correspond to an original list or data point included within the initial dataset 104.

As an illustrative example and as illustrated in FIG. 5, the dataset generator 208 may define a first column that is associated with a first encoding group (i.e., Group 0). This particular group may incorporate the encoding group including the list elements [red, cyan, black] as identified from the different element clusters represented in the adjacency graph. The dataset generator 208 may further define a second column that is associated with a second encoding group (i.e., Group 1) from the set of encoding groups 408. This second group may incorporate the encoding group including the list elements [blue, yellow, white] as identified from the sets of adjacencies and element relationships represented in the adjacency graph. The final column within the optimized dataset 108 may be associated with the third and final encoding group (i.e., Group 2). This final group may incorporate the encoding group including the list elements [green, magenta] as identified from the adjacency graph.

As noted above, each row within the optimized dataset 108 may correspond to each data point or list originally included in the initial dataset 104. In an embodiment, the dataset generator 208, for each of these data points or lists included in the initial dataset 104 and added to the optimized dataset 108, deconstructs the data point or list into its constituent elements and indicates the presence of these elements under the corresponding encoding group column. For example, as illustrated in FIG. 5, for the data point including the elements red, green, and blue, the dataset generator 208 may deconstruct this data point and input the text “red” under the column corresponding to the encoding group [red, cyan, black], the text “blue” under the column corresponding to the encoding group [blue, yellow, white], and the text “green” under the column corresponding to the encoding group [green, magenta]. The configuration of the different encoding groups 408 and, hence, the columns within the optimized dataset 108 thus ensures that each data point can be represented by, at most, one element within each encoding group or column in the optimized dataset 108. The dataset generator 208 may provide this newly generated optimized dataset 108 to a requesting user for use in training machine learning algorithms. Alternatively, the dataset generator 208 may automatically use the newly generated optimized dataset 108 to train one or more machine learning algorithms implemented by a system or service that provides the dataset optimization system.

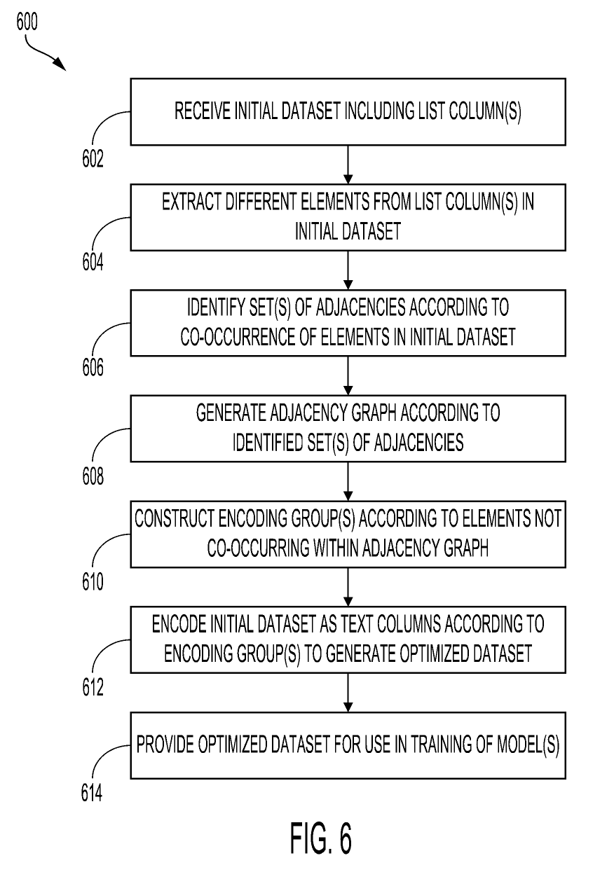

FIG. 6 shows an illustrative example of a process for generating an optimized dataset including columns according to a set of encoding groups constructed according to elements not co-occurring within an initial dataset in accordance with at least one embodiment. The process 600 may be performed by the various components of the dataset optimization system, as described above in connection with FIGS. 2-5.

At step 602, the dataset optimization system may receive an initial dataset including a set of list columns. As noted above, a list column within an initial dataset may include a set of string values within each row. Returning to the illustrative example described above in connection with FIG. 1, an exemplary initial dataset may include a single list column corresponding to different colors that are included in each distinct data point within the initial dataset. A row (i.e., a particular data point) within the initial dataset 104 may include a list of three colors: red, green, and blue; the second row, or data point, within the initial dataset may include a list of two colors: red and blue; and so on. Accordingly, the initial dataset may provide, for each datapoint, a distinct list of elements. However, certain machine learning algorithms may be unable to support datasets including this list type natively. Thus, the initial dataset may need to be transformed into a new dataset that provides these data points in a format that can be processed by these machine learning algorithms.

At step 604, the dataset optimization system may extract the different elements from the set of list columns included in the initial dataset. For instance, the dataset optimization system may evaluate the initial dataset to identify the universe of possible elements or string values that make up the different data points within the initial dataset. In some instances, the dataset optimization system may allow users to provide, along with an initial dataset, an indication of a universe of possible list elements that may be included in the initial dataset. If a user of the dataset optimization system defines a universe of possible list elements, the dataset optimization system may evaluate the initial dataset to determine whether any elements defined by the user are absent from the initial dataset. If the dataset optimization system identifies, based on its evaluation of the initial dataset and the provided universe of possible list elements, that one or more indicated elements are absent from the initial dataset (i.e., no data point or list includes the one or more indicated elements), the dataset optimization system may indicate that the initial dataset does not include these one or more elements within any of the data points of the initial dataset. This may cause the user to revise their definition of the universe of possible list elements. In some instances, the dataset optimization system may automatically remove any elements from the universe of possible list elements that are not present within the initial dataset.

In some embodiments, the dataset optimization system may further revise the universe of possible list elements based on the frequency in which each element appears in the initial dataset. For instance, the dataset optimization system may evaluate the initial dataset to tabulate or record the number of times each element occurs within the initial dataset in relation to the number of data points or lists included in the initial dataset. The dataset optimization system may implement a threshold frequency value or other frequency threshold that may be used to determine whether to include an element within the universe of possible list elements for processing of the initial dataset. The threshold frequency value or other frequency threshold may denote the minimum frequency (e.g., number of times, appearance ratio or percentage, etc.) that an element is required to appear in the initial dataset in order to be included in the universe of possible list elements that is to be used for creation of an optimized dataset. In some instances, the threshold frequency value or other frequency threshold may be pre-defined, whereby the dataset optimization system or other entity (e.g., an administrator of the dataset optimization system, etc.) may implement a default threshold frequency value or other frequency threshold for evaluating initial datasets. If the dataset optimization system identifies, from the initial dataset, a list element that does not satisfy this threshold frequency value or other frequency threshold, the dataset optimization system may omit this element from the universe of possible list elements that may be considered when generating the optimized dataset.

At step 606, the dataset optimization system may identify different sets of adjacencies among the list elements included in the initial dataset according to the co-occurrence of these different list elements. To identify these different sets of adjacencies, the dataset optimization system may process the different data points from the initial dataset in accordance with the identified universe of possible list elements. As noted above, a set of adjacencies may be identified by identifying different list elements that are co-occurring within the initial dataset and, thus, defines a relationship amongst these different list elements. Returning to the illustrative example presented in FIG. 1, from the data points extracted from the initial dataset, the dataset optimization system may identify a first set of adjacencies corresponding to the elements red, green, and blue. When the dataset optimization system processes the fourth data point of the initial dataset (e.g., the list comprising the elements yellow and cyan), the dataset optimization system may initially identify a new set of adjacencies corresponding to the elements yellow and cyan. However, upon processing the fifth data point (e.g., the list comprising the elements cyan and magenta), the dataset optimization system may determine that the element cyan, which co-occurs with the element yellow, also co-occurs with the element magenta. Accordingly, the dataset optimization system may dynamically expand this new set of adjacencies to include the element magenta, resulting in the new set of adjacencies corresponding to the elements yellow, cyan, and magenta. As noted above, in some instances, the dataset optimization system may implement a greedy set creation algorithm to identify the sets of adjacencies from the initial dataset.

At step 608, the dataset optimization system may generate an adjacency graph according to the identified sets of adjacencies among the list elements of the initial dataset. Each set of adjacencies represented in this adjacency graph may be represented by a set of nodes corresponding to the list elements associated with the set of adjacencies and a set of edges connecting these different nodes within the set of adjacencies according to their co-occurrence within one or more data points or lists in the initial dataset. Each edge connecting a pair of nodes may be labeled to include identifiers corresponding to the data points (e.g., lists) that include the list elements corresponding to these nodes, highlighting the adjacencies among these list elements within the indicated data points. As noted above, in some instances, the resulting sets of adjacencies and the adjacency graph may incorporate the list elements belonging to the universe of possible list elements as determined by the dataset optimization system. In some instances, the dataset optimization system may provide this adjacency graph to users of the dataset optimization system through a GUI or other interface provided to these users. This may allow a user to evaluate the different sets of adjacencies identified by the dataset optimization system corresponding to the different list elements within the initial dataset.

At step 610, the dataset optimization system may construct, according to the adjacency graph, a set of encoding groups including list elements that do not co-occur within the initial dataset. To generate a new encoding group, the dataset optimization system may select an element from each set of adjacencies from the adjacency graph and create a new list that includes these selected and non-co-occurring elements. As these elements are selected from distinct sets of adjacencies from the adjacency graph, the elements included in the new encoding group are not co-occurring within the initial dataset. The set of encoding groups may be generated such that, for each data point or list provided in the initial dataset, only one list element from the data point or list can be represented by an encoding group. The configuration of these encoding groups thus ensures that for each data point or list provided in an initial dataset, an entry corresponding to a particular encoding group may include, at most, one element from the data point or list.

At step 612, the dataset optimization system may encode the initial dataset as text-based columns according to the identified encoding groups to generate a new optimized dataset. A text-based column within the optimized dataset may correspond to a particular encoding group generated from the set of element clusters. Further, each row within the optimized dataset may correspond to an original list or data point included within the initial dataset. The dataset optimization system, in an embodiment, represents or otherwise encodes a data point or list within the optimized dataset using the actual and distinct list elements included in the data point and according to the encoding groups (i.e., columns) represented in the optimized dataset. Returning to the earlier illustrative example provided in FIG. 1, where the first data point from the initial dataset includes the elements red, green, and blue and the dataset optimization system has generated three distinct encoding groups (i.e., encoding group [red, cyan, black], encoding group [blue, yellow, white], and encoding group [green, magenta]), the dataset optimization system may define this first data point within the optimized dataset by including the text “red” under the column corresponding to the first encoding group (i.e., [red, cyan, black]), the text “blue” under the column corresponding to the second encoding group (i.e., [blue, yellow, white]), and the text “green” under the column corresponding to the third encoding group (i.e., [green, magenta]). The dataset optimization system, at step 614, may provide this newly generated optimized dataset to a requesting user for use in training machine learning algorithms. Alternatively, the dataset optimization system may automatically use the newly generated optimized dataset to train one or more machine learning algorithms implemented by a system or service that provides the dataset optimization system.

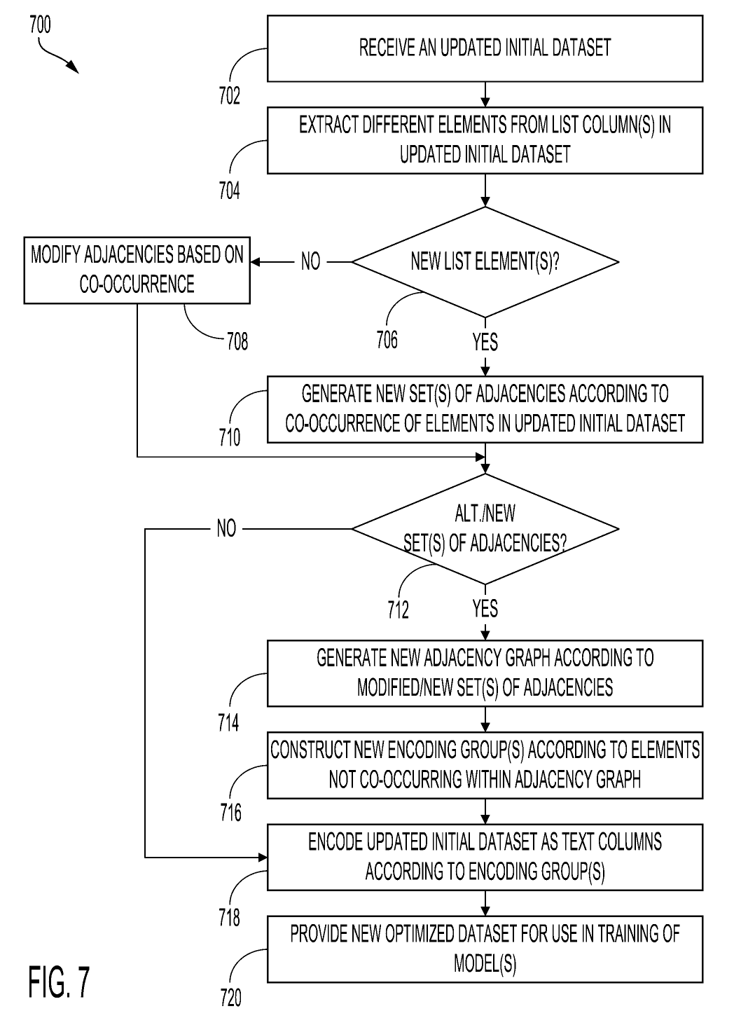

FIG. 7 shows an illustrative example of a process 700 for updating an optimized dataset in response to receiving an updated initial dataset in accordance with at least one embodiment. The process 700 may be performed by the various components of the dataset optimization system, as described above in connection with FIGS. 2-5.

At step 702, the dataset optimization system may receive an updated initial dataset. For instance, a user of the dataset optimization system may provide a new dataset that includes, in addition to the original data points or lists included in the original initial dataset, a new set of data points or lists that were not previously processed by the dataset optimization system. As this new dataset may include additional data points or lists, the new dataset may need to be encoded in an optimized dataset for use in training machine learning algorithms.

At step 704, the dataset optimization system may extract the different elements from the set of list columns included in the updated initial dataset. Similar to step 604 described above in connection with the process 600, the dataset optimization system may evaluate the updated initial dataset to identify the universe of possible elements or string values that make up the different data points within the updated initial dataset. If a user of the dataset optimization system defines a universe of possible list elements for the updated initial dataset, the dataset optimization system may evaluate the initial dataset to determine whether any elements defined by the user are absent from the updated initial dataset. If the dataset optimization system identifies, based on its evaluation of the updated initial dataset and the provided universe of possible list elements, that one or more indicated elements are absent from the updated initial dataset (i.e., no data point or list includes the one or more indicated elements), the dataset optimization system may indicate that the updated initial dataset does not include these one or more elements within any of the data points of the updated initial dataset. This may cause the user to revise their definition of the universe of possible list elements. In some instances, the dataset optimization system may automatically remove any elements from the universe of possible list elements that are not present within the updated initial dataset.

At step 706, the dataset optimization system may determine whether the updated initial dataset includes any new list elements that were not previously present in the original initial dataset. For instance, the dataset optimization system may compare the new universe of possible list elements (as determined through evaluation of the updated initial dataset) to the universe of possible list elements generated from a prior iteration of the initial dataset (e.g., the original initial dataset, an immediately preceding version of the initial dataset, etc.). In some instances, the updated initial dataset may be classified as including new list elements even if the updated initial dataset and a prior iteration of the initial dataset includes the same list elements. As noted above, the dataset optimization system may implement a threshold frequency value or other frequency threshold that may be used to determine whether to include an element within the universe of possible list elements for processing of the initial dataset. As the updated initial dataset may include additional data points or lists, a list element that was previously omitted for not satisfying the threshold frequency value or other frequency threshold may now satisfy the threshold frequency value or other frequency threshold. Accordingly, this list element may be added to the universe of possible list elements and is considered to be a new list element that can be used to define element clusters and encoding groups.

If the dataset optimization system determines that the updated initial dataset does not include any new list elements, the dataset optimization system, at step 708, may modify the previously generated sets of adjacencies for the initial dataset according to the co-occurrence of different list elements within the updated initial dataset. For instance, while the updated initial dataset may include the same universe of possible list elements, the new data points or lists within the updated initial dataset may indicate additional list element co-occurrences that were not previously present in older iterations of the initial dataset. These additional list element co-occurrences can have an impact on the definition of the adjacency graph and, hence, encoding groups that are used to generate optimized datasets. Thus, at step 708, the dataset optimization system may evaluate the different data points or lists within the updated initial dataset to identify any new list element adjacencies and, accordingly, modify the previously generated sets of adjacencies. The modification of the sets of adjacencies may be performed according to the processes described above in connection with step 606 of the process 600 (e.g., through a greedy set creation algorithm, etc.). In some instances, the dataset optimization system may determine that there are no new co-occurrences within the updated initial dataset. Accordingly, the dataset optimization system may not be required to modify the previously generated sets of adjacencies and the adjacency graph.

If the dataset optimization system determines that the updated initial dataset does include one or more new list elements within the new universe of possible list elements, the dataset optimization system, at step 710, may identify new sets of list element adjacencies according to the co-occurrence of list elements in the updated initial dataset. The new sets of adjacencies may be generated according to the processes described above in connection with step 606 of the process 600.

At step 712, the dataset optimization system may determine whether the new and/or alternative sets of adjacencies have been identified from the updated initial dataset. For instance, if the updated initial dataset does not include any new list elements and does not define new co-occurrences among the different list elements in the existing universe of possible list elements, the dataset optimization system may determine that there are no new adjacencies that need to be considered when generating the encoding groups that are to be used to define the optimized dataset. Accordingly, the dataset optimization system may, at step 718, encode the updated initial dataset into an optimized dataset including columns corresponding to previously generated encoding groups. This encoding process may include adding new rows to an existing optimized dataset to incorporate the new data points or lists provided in the updated initial dataset.

If the dataset optimization system identifies alternative and/or new sets of adjacencies among the list elements from the updated initial dataset, the dataset optimization system, at step 714, may generate a new adjacency graph according to the new and/or alternative sets of adjacencies. As noted above, each set of adjacencies represented in this adjacency graph may be represented by a set of nodes corresponding to the list elements included in the set of adjacencies and a set of edges connecting these different nodes within the set of adjacencies according to their co-occurrence within one or more data points or lists in the initial dataset. Each edge connecting a pair of nodes may be labeled to include identifiers corresponding to the data points (e.g., lists) that include the list elements corresponding to these nodes, highlighting the co-occurrence of these list elements within the indicated data points. The resulting sets of adjacencies and the adjacency graph may incorporate the list elements belonging to the new universe of possible list elements as determined by the dataset optimization system from the updated initial dataset.

At step 716, the dataset optimization system may construct a new set of encoding groups according to list elements not co-occurring within the newly generated adjacency graph. Similar to step 610 of the process 600 described above in connection with FIG. 6, the dataset optimization system may select an element from each set of adjacencies within the adjacency graph and create a new list that includes these selected and non-co-occurring elements. As these elements are selected from distinct sets of adjacencies, the elements included in the new encoding group are not co-occurring within the initial dataset. The set of encoding groups may be generated such that, for each data point or list provided in the initial dataset, only one list element from the data point or list can be represented by an encoding group. The configuration of these encoding groups thus ensures that for each data point or list provided in an initial dataset, an entry corresponding to a particular encoding group may include, at most, one element from the data point or list.

At step 718, the dataset optimization system may encode the updated initial dataset as text-based columns according to the newly identified encoding groups to generate a new optimized dataset. As noted above, a text-based column within the optimized dataset may correspond to a particular encoding group generated from the set of element clusters. Further, each row within the optimized dataset may correspond to an original list or data point included within the initial dataset. The dataset optimization system, in an embodiment, represents or otherwise encodes a data point or list within the optimized dataset using the actual and distinct list elements included in the data point and according to the encoding groups (i.e., columns) represented in the optimized dataset. The dataset optimization system, at step 720, may provide this newly generated optimized dataset to a requesting user for use in training machine learning algorithms. Alternatively, the dataset optimization system may automatically use the newly generated optimized dataset to train one or more machine learning algorithms implemented by a system or service that provides the dataset optimization system.

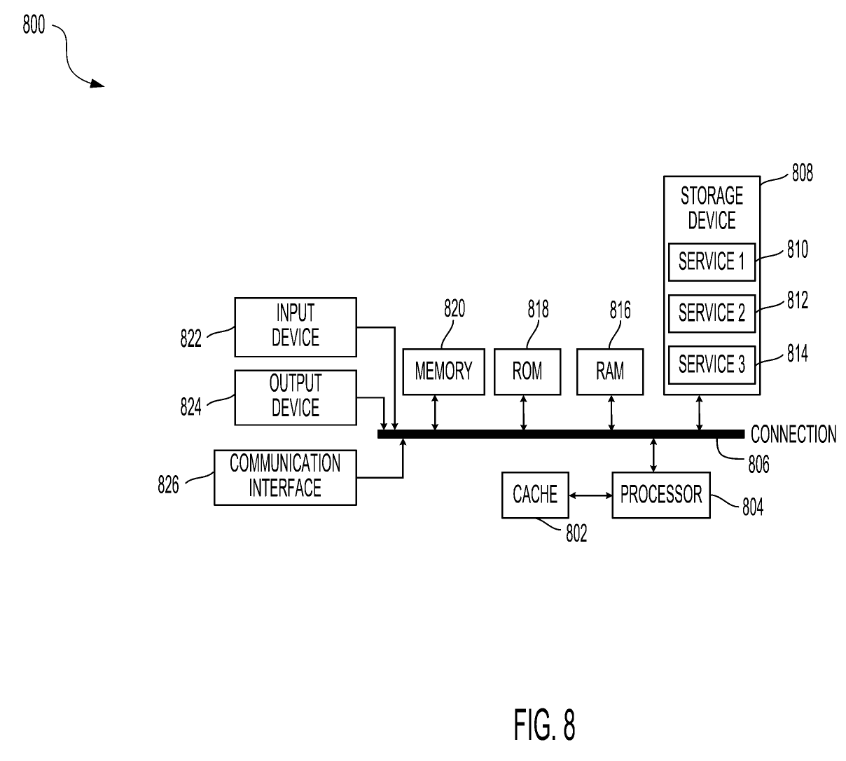

FIG. 8 illustrates a computing system architecture 800 including various components in electrical communication with each other using a connection 806, such as a bus, in accordance with some implementations. Example system architecture 800 includes a processing unit (CPU or processor) 804 and a system connection 806 that couples various system components including the system memory 820, such as ROM 818 and RAM 816, to the processor 804. The system architecture 800 can include a cache 802 of high-speed memory connected directly with, in close proximity to, or integrated as part of the processor 804. The system architecture 800 can copy data from the memory 820 and/or the storage device 808 to the cache 802 for quick access by the processor 804. In this way, the cache can provide a performance boost that avoids processor 804 delays while waiting for data. These and other modules can control or be configured to control the processor 804 to perform various actions.

Other system memory 820 may be available for use as well. The memory 820 can include multiple different types of memory with different performance characteristics. The processor 804 can include any general purpose processor and a hardware or software service, such as service 1810, service 2812, and service 3814 stored in storage device 808, configured to control the processor 804 as well as a special-purpose processor where software instructions are incorporated into the actual processor design. The processor 804 may be a completely self-contained computing system, containing multiple cores or processors, a bus, memory controller, cache, etc. A multi-core processor may be symmetric or asymmetric.

To enable user interaction with the computing system architecture 800, an input device 822 can represent any number of input mechanisms, such as a microphone for speech, a touch-sensitive screen for gesture or graphical input, keyboard, mouse, motion input, speech and so forth. An output device 824 can also be one or more of a number of output mechanisms known to those of skill in the art. In some instances, multimodal systems can enable a user to provide multiple types of input to communicate with the computing system architecture 800. The communications interface 826 can generally govern and manage the user input and system output. There is no restriction on operating on any particular hardware arrangement and therefore the basic features here may easily be substituted for improved hardware or firmware arrangements as they are developed.

Storage device 808 is a non-volatile memory and can be a hard disk or other types of computer readable media which can store data that are accessible by a computer, such as magnetic cassettes, flash memory cards, solid state memory devices, digital versatile disks, cartridges, RAMs 816, ROM 818, and hybrids thereof.

The storage device 808 can include services 810, 812, 814 for controlling the processor 804. Other hardware or software modules are contemplated. The storage device 808 can be connected to the system connection 806. In one aspect, a hardware module that performs a particular function can include the software component stored in a computer-readable medium in connection with the necessary hardware components, such as the processor 804, connection 806, output device 824, and so forth, to carry out the function.

The disclosed methods can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

The disclosed methods can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system. In some embodiments, the disclosed methods can be performed using virtualized environments.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor. In some embodiments, the data may be encrypted.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor. In some embodiments, the software may be encrypted.

The bus can also couple the processor to the network interface device. The interface can include one or more of a modem or network interface. It will be appreciated that a modem or network interface can be considered to be part of the computer system. The interface can include an analog modem, Integrated Services Digital network (ISDN modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, WA, and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually affect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
receiving an initial dataset for training of a machine learning algorithm, wherein the initial dataset includes a set of list columns, and wherein the set of list columns includes corresponding sets of string values;
extracting individual string values from the sets of string values;
generating an adjacency graph over the individual string values, wherein adjacencies in the adjacency graph are defined according to co-occurrence of the individual string values within the initial dataset;
constructing a set of encoding groups, wherein the set of encoding groups is generated according to different string values not mutually adjacent according to the adjacency graph;
generating an optimized dataset, wherein the optimized dataset is generated by encoding the initial dataset as a set of columns according to the set of encoding groups; and
providing the optimized dataset, wherein when the optimized dataset is provided, the optimized dataset is used to train the machine learning algorithm.

2. The computer-implemented method of claim 1, wherein the adjacency graph includes nodes corresponding to the individual string values and a set of edges corresponding to the adjacencies.

3. The computer-implemented method of claim 1, further comprising:
determining that a frequency of occurrence associated with a string value within the initial dataset fails to satisfy a threshold frequency value; and
omitting the string value from the adjacency graph.

4. The computer-implemented method of claim 1, wherein an encoding group from the set of encoding groups is generated by selecting mutually non-adjacent elements according to the adjacency graph.

5. The computer-implemented method of claim 1, further comprising:
receiving an update to the initial dataset, wherein the update includes a new set of list columns and a corresponding new set of string values;
modifying the adjacency graph and the set of encoding groups according to the new set of string values; and
generating a new optimized dataset according to the modified set of encoding groups.

6. The computer-implemented method of claim 1, wherein the set of columns is defined such that an individual column from the set of columns corresponds to an individual encoding group from the set of encoding groups.

7. The computer-implemented method of claim 1, wherein the adjacency graph is generated using a greedy set creation algorithm.

8. A system, comprising:
one or more processors; and
memory storing thereon instructions that, as a result of being executed by the one or more processors, cause the system to:
receive an initial dataset for training of a machine learning algorithm, wherein the initial dataset includes a set of list columns, and wherein the set of list columns includes corresponding sets of string values;
extract individual string values from the sets of string values;
generate an adjacency graph over the individual string values, wherein adjacencies in the adjacency graph are defined according to co-occurrence of the individual string values within the initial dataset;
construct a set of encoding groups, wherein the set of encoding groups is generated according to different string values not mutually adjacent according to the adjacency graph;
generate an optimized dataset, wherein the optimized dataset is generated by encoding the initial dataset as a set of columns according to the set of encoding groups; and
provide the optimized dataset, wherein when the optimized dataset is provided, the optimized dataset is used to train the machine learning algorithm.

9. The system of claim 8, wherein the adjacency graph includes nodes corresponding to the individual string values and a set of edges corresponding to the adjacencies.

10. The system of claim 8, wherein the instructions further cause the system to:
determine that a frequency of occurrence associated with a string value within the initial dataset fails to satisfy a threshold frequency value; and
omit the string value from the adjacency graph.

11. The system of claim 8, wherein an encoding group from the set of encoding groups is generated by selecting mutually non-adjacent elements according to the adjacency graph.

12. The system of claim 8, wherein the instructions further cause the system to:
receive an update to the initial dataset, wherein the update includes a new set of list columns and a corresponding new set of string values;
modify the adjacency graph and the set of encoding groups according to the new set of string values; and
generate a new optimized dataset according to the modified set of encoding groups.

13. The system of claim 8, wherein the set of columns is defined such that an individual column from the set of columns corresponds to an individual encoding group from the set of encoding groups.

14. The system of claim 8, wherein the adjacency graph is generated using a greedy set creation algorithm.

15. A non-transitory computer-readable storage medium storing thereon executable instructions that, as a result of being executed by one or more processors of a computer system, cause the computer system to:
receive an initial dataset for training of a machine learning algorithm, wherein the initial dataset includes a set of list columns, and wherein the set of list columns includes corresponding sets of string values;
extract individual string values from the sets of string values;
generate an adjacency graph over the individual string values, wherein adjacencies in the adjacency graph are defined according to co-occurrence of the individual string values within the initial dataset;
construct a set of encoding groups, wherein the set of encoding groups is generated according to different string values not mutually adjacent according to the adjacency graph;
generate an optimized dataset, wherein the optimized dataset is generated by encoding the initial dataset as a set of columns according to the set of encoding groups; and
provide the optimized dataset, wherein when the optimized dataset is provided, the optimized dataset is used to train the machine learning algorithm.

16. The non-transitory computer-readable storage medium of claim 15, wherein the adjacency graph includes nodes corresponding to the individual string values and a set of edges corresponding to the adjacencies.

17. The non-transitory computer-readable storage medium of claim 15, wherein the executable instructions further cause the computer system to:
determine that a frequency of occurrence associated with a string value within the initial dataset fails to satisfy a threshold frequency value; and
omit the string value from the adjacency graph.

18. The non-transitory computer-readable storage medium of claim 15, wherein an encoding group from the set of encoding groups is generated by selecting mutually non-adjacent elements according to the adjacency graph.

19. The non-transitory computer-readable storage medium of claim 15, wherein the executable instructions further cause the computer system to:
receive an update to the initial dataset, wherein the update includes a new set of list columns and a corresponding new set of string values;
modify the adjacency graph and the set of encoding groups according to the new set of string values; and
generate a new optimized dataset according to the modified set of encoding groups.

20. The non-transitory computer-readable storage medium of claim 15, wherein the set of columns is defined such that an individual column from the set of columns corresponds to an individual encoding group from the set of encoding groups.

21. The non-transitory computer-readable storage medium of claim 15, wherein the adjacency graph is generated using a greedy set creation algorithm.
